(19) United States
(12) Patent Application Publication
(10) Pub. No.: US 2007/0009709 A1
(43) Pub. Date: Jan. 11, 2007

(54) Method to modify surface of an article and the article obtained therefrom

(75) Inventors: Kasiraman Krishnan, Niskayuna, NY (US); Fazila Seker, Clifton Park, NY (US); Suryaprakash Ganti, Sunnyvale, CA (US); Gregory Allen O'Neil, Clifton Park, NY (US); Judith Stein, Schenectady, NY (US); Tao Deng, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/176,893

(22) Filed: Jul. 7, 2005

(51) Int. Cl. B29C 47/00; G11B 5/64

(52) U.S. Cl. 428/141; 428/36.9

(57) ABSTRACT

A method for making an article with controlled surface wettability is provided. The method includes the steps of providing a substrate including a polymer; and inducing a phase transformation at a selected surface region of the substrate, such that the phase transformation forms a texture at the selected surface region. The texture includes a plurality of features having a largest characteristic dimension of up to about 50 microns. An article with controlled wettability is provided. The article has a selected surface region including a polymer. At least about 80% of surface area includes a plurality of features having a largest characteristic dimension of up to about 50 microns. The plurality of features further includes a plurality of nanoscale surface features and the selected surface region has the surface wettability sufficient to generate, with a reference fluid, a static contact angle of at least about 120° C.

### BACKGROUND

The invention relates generally to a method to modify the surface of an article. More particularly, the invention relates to a method to modify the surface of an article so as to alter its wettability. The invention also relates to an article with a modified surface.

Polymer surfaces have been used extensively in a variety of applications, for example, as biomaterials, as protective coatings, as a coating to alter friction and wear, in automotive parts, in microelectronic devices, and as thin film sensors. Specific surface properties such as chemical composition, wettability, roughness, crystallinity, conductivity, and lubricity may be required for utilizing these materials for specific applications. The polymers, which have suitable bulk physical and chemical properties, may not possess these specific surface properties needed for a particular application. However, polymers are inexpensive and easy to process. For these reasons, surface modification of polymers to achieve specific surface properties has become an extremely important technique in plastics industry. There are many methods developed over the last few years to modify surface properties such as wettability of surfaces. Most extensively used techniques include plasma treatment, lithography, physical deposition/adsorption, grafting etc. Most of these existing techniques may be time consuming, difficult to control, expensive, or suffer from poor durability of coated films. Therefore, there is a need for an inexpensive, easy, and effective means for achieving surfaces with controlled wettability.

### SUMMARY OF THE INVENTION

The present invention meets these and other needs by providing a method for making an article with controlled surface wettability. The method includes the steps of providing a substrate comprising a polymer; and inducing a phase transformation at a selected surface region of the substrate, such that the phase transformation forms a texture at the selected surface region. The texture includes a plurality of features having a largest characteristic dimension of up to about 50 microns.

Accordingly, in one exemplary embodiment of the invention, a method for making an article is provided. The method includes the steps of providing a substrate including a polycarbonate material; contacting a selected surface region of the substrate with a fluid including acetone to induce a phase transformation at the selected surface region; evaporating the fluid from the surface such that a texture is formed at the selected surface region; and altering surface chemistry of the selected surface region. The texture includes a plurality of features having a largest characteristic dimension of up to about 50 microns, and the features are disposed on at least about 80% of the area of the selected surface region of the substrate. The surface has wettability sufficient to generate, with a reference fluid, a static contact angle of at least about 120 degrees.

Accordingly, in another embodiment of the invention, a method for making an article is provided. The method includes the steps of providing a substrate including a copolymer comprising a polycarbonate and a siloxane; contacting a selected surface region of the substrate with a fluid comprising acetone to induce a phase transformation at the selected surface region; and evaporation of fluid from the surface such that a texture is formed at the selected surface region. The texture includes a plurality of features having a largest characteristic dimension of up to about 50 microns, and the features are disposed on at least about 80% surface area of selected surface region of the substrate. The surface has wettability sufficient to generate, with a reference fluid, a static contact angle of at least about 120 degrees.

A second aspect of the invention is to provide an article. The article has a selected surface region including a polymer. At least about 80% of the surface area of the selected surface region includes a plurality of features having a largest characteristic dimension of up to about 50 microns. The plurality of features further includes a plurality of nanoscale surface features and the selected surface region has the surface wettability sufficient to generate, with a reference fluid, a static contact angle of at least about 120° C.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1-3 are flow charts illustrating methods for making an article according to some embodiments of the present invention;

FIGS. 4 and 5 are schematics of a process flow of the method for making an article according to some embodiments of the present invention;

FIGS. 6 and 7 are flow charts illustrating methods for making an article according to some embodiments of the present invention;

FIG. 8 shows scanning electron micrographs of surfaces from the examples, produced according to some embodiments of the present invention;

FIG. 9 is an optical micrograph of a water droplet on a surface, produced according to some embodiments of the present invention, demonstrating its hydrophobicity; and

FIG. 10 is a schematic of a water droplet on a superhydrophobic surface.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular aspect of the invention is to comprise or consist of at least one of a number of elements of a group and combinations thereof, it is understood that the aspect may comprise or consist of any of the elements of the group, either individually or in combination with any of the other elements of that group.

Referring to the drawings in general, it will be understood that the illustrations are for the purpose of describing one embodiment of the invention and are not intended to limit the invention thereto.

As used herein, “phase transformation” implies a transformation of the material from one phase to another phase such as a phase change or a phase separation. “Phase change” as used herein includes transitions from crystalline to amorphous phases, or transitions from amorphous to crystalline phases, or transitions from or to glassy phases, or transitions from immiscibility to miscibility of the polymer in a solvent. “Phase separation” implies the separation of a multiphase material into constituent phases. “Phase separation” also occur in single phase materials when dissolution of material from the surface is followed by precipitation back onto the surface. “Surface region”, as used herein includes the surface and a region to about 150 microns below the surface. As used herein, the “contact angle” or “static contact angle” is the angle formed between a stationary drop of a reference liquid at the liquid/substrate interface relative to the plane of the model surface, “advancing contact angle” is the static contact angle measured at the plateau during addition of water droplets, and the “receding contact angle” is the static contact angle measured as equivalent volume droplets of fluid are successively retracted from the droplet. Advancing and receding contact angles are angles measured when the three-phase boundary (liquid/solid/vapor) is in motion.

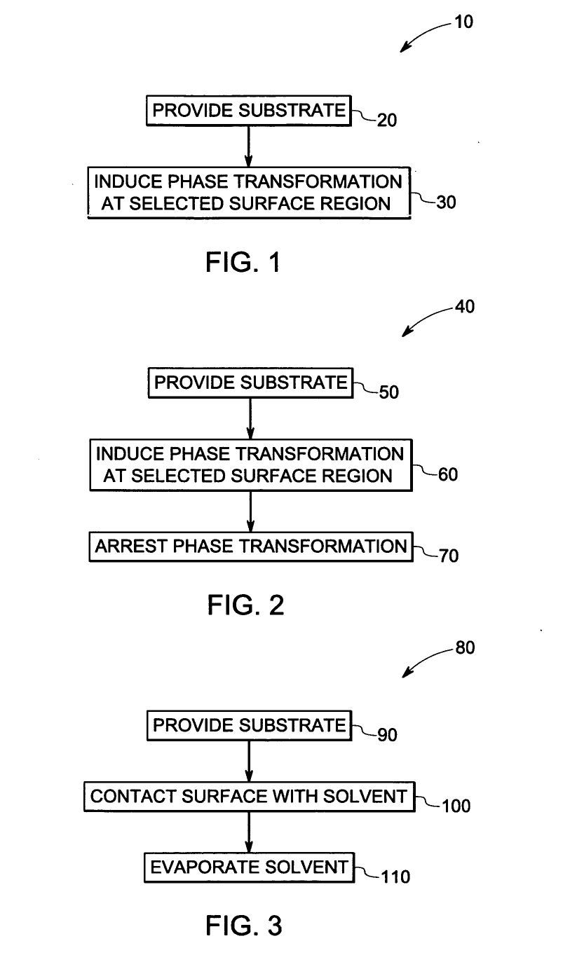

In some embodiments, the present invention demonstrates a simple and efficient method to prepare articles with controlled wettability. FIG. 1 illustrates a flowchart of a method for making an article. The method 10 includes the steps of providing a substrate including a polymer in step 20, and inducing a phase transformation at a selected surface region of the substrate in step 30, such that the phase transformation forms a texture at the selected surface region. The process is controlled such that the texture includes a plurality of features having a largest characteristic dimension of up to about 50 microns.

The substrate may include any of the wide variety of commonly available polymers. The polymer may be a glassy, or a crystallizable, or a rubbery polymer. The non-limiting examples of suitable polymers include polycarbonates, polyolefins, polyacrylamides, polystyrenes, polyesters, polyurethane, acrylics, blends or copolymers of these. A copolymer may also include monomers from other class of polymers. The substrate may be taken in the form of a sheet, a film, a rod or a tube include a composite. A composite may be a hybrid organic-inorganic material, such as polymer ceramic composite, or polymer-metal composite. Polymer may also be a copolymer comprising a hydrophobic component. In an exemplary embodiment, the copolymer includes a polycarbonate and a polysiloxane.

The phase transformation may be a phase change or a phase separation. In some embodiments, phase separation is separation of a multi-phase into constituent phases. In some other embodiments, phase separation includes dissolution of material from the surface followed by precipitation back onto the surface. The phase change may include at least one of a transition from a crystalline to an amorphous structure, a transition from amorphous to a crystalline phase, a transition from a glassy phase, a transition to a glassy phase a transition from immiscibility to miscibility of polymer-solvent system, or a transition from immiscibility to miscibility of a polymer-polymer blend.

The phase transformation may be induced at the surface region by a variety of means. In one embodiment, inducing the phase transformation at the surface region comprises contacting the surface region with a fluid. A variety of liquid or gaseous fluids may be used. The most generally used fluid includes organic solvents. Generally a poor solvent for a chosen polymer may be preferred. A poor solvent has a small solubility limit for a polymer. Non-limiting examples of suitable solvents include acetone, butyl acetate, water, ethanol, and tetrahydrofuran. A suitable combination of those may also be used, either as a mixture or sequentially one solvent after another. Typically a combination of a good and a poor solvent may be chosen for a particular polymer. A good solvent is one that has a higher solubility limit for a particular polymer. In an exemplary embodiment, the fluid is chosen is a poor solvent such as acetone, when the polymer chosen is a polycarbonate. In another exemplary embodiment, the fluid is butyl acetate, when the polymer chosen is a polycarbonate. In another exemplanary embodiment, the solvent mixture chosen is either acetone/water or acetone/ethanol, when the polymer chosen is a polycarbonate. As an exemplary embodiment, a mixture of a good and a poor solvent such as tetrahydrofuran and ethanol are chosen, when the chosen polymer is a polycarbonate. In another exemplary embodiment, the fluid includes supercritical carbon dioxide. A fluid may be a mild acid or an alkali. The substrate may be contacted with a fluid by spray application, doctor blade application, drop application, by dipping the substrate in a solvent, or any other method of contact, depending on convenience and the requirements of the particular application.

The method for making an article may optionally include arresting the phase transformation. The nature of the texture, such as the size and/or number of features formed, may be controlled by arresting the phase transformation at an appropriate time. FIG. 2 illustrates a flow chart of a method according to one embodiment of the present invention for making an article. The method 40 starts with step 50, wherein a substrate including a polymer at the selected surface region is provided. In step 60, a phase transformation is induced at the selected surface region. And in step 70, the phase transformation is arrested. In some embodiments as shown as method 80 in FIG. 3, after providing a substrate in step 90, inducing the phase transformation at the selected surface region includes contacting the surface with a fluid (step 100), and arresting the phase transformation comprises evaporation of fluid from the surface (step 110). In an exemplary embodiment, during evaporation of the solvent, a texture is created by solvent-induced crystallization. In the case of glassy polymers, dissolution of the polymer may be followed by phase separation and trapping of network structure during rapid solvent evaporation leading to surface texture. The texture may be controlled by controlling the contact time of the surface with the fluid, by choosing a proper fluid, temperature of the substrate, and various other parameters.

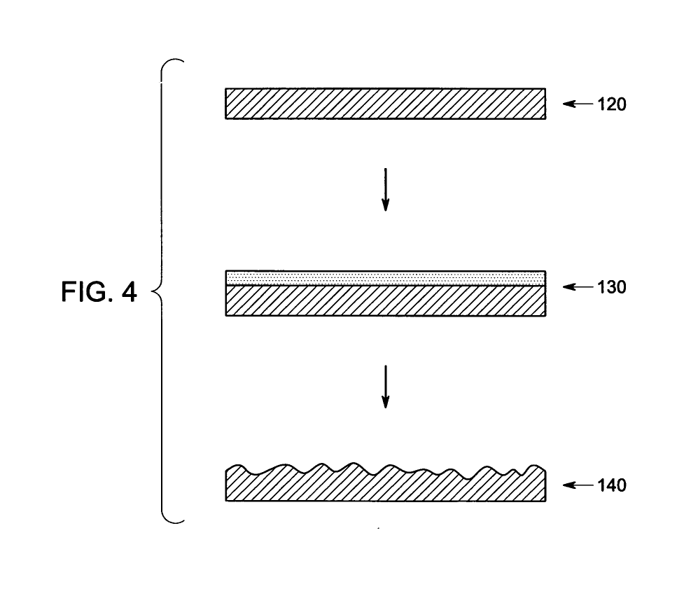

FIG. 4 illustrates schematically the process flow for making an article with modified surface. Typically the process starts with providing a substrate 120 of any desired shape and size. The substrate is brought in contact with a suitable solvent 130. Evaporation of the solvent leaves behind a surface texture including a plurality of features. The polymer-solvent system and the rate of evaporation are controlled to control the surface texture and the wettability of article 140.

In some embodiments, the method for making the article may further include altering the surface chemistry of the textured surface to achieve a desired wettability of the surface region. The surface region may be modified by several of known processes. Modification processes may be selected from the group consisting of deposition of a coating on the surface, or exposing the surface to a radiation, or exposing the surface to plasma. Either a hydrophobic or hydrophilic coatings may be deposited to decrease or increase the wettability respectively. Deposition of a coating may be done either from vapor or a liquid phase. Deposition of a hydrophobic coating may include coating the surface with hydrophobic lacquers including fluorine or a silicone moiety, a silane or a flurosilane layer, or a coating of diamond-like carbon (DLC) layer. Non-limiting examples of suitable fluorosilanes are tridecafluoro 1,1,2,2-tetrahydroflouro octyl trichlorosilane. FIG. 5 illustrates schematically a method of FIG. 4 including an additional step of depositing a suitable coating 150 to achieve the desired wettability.

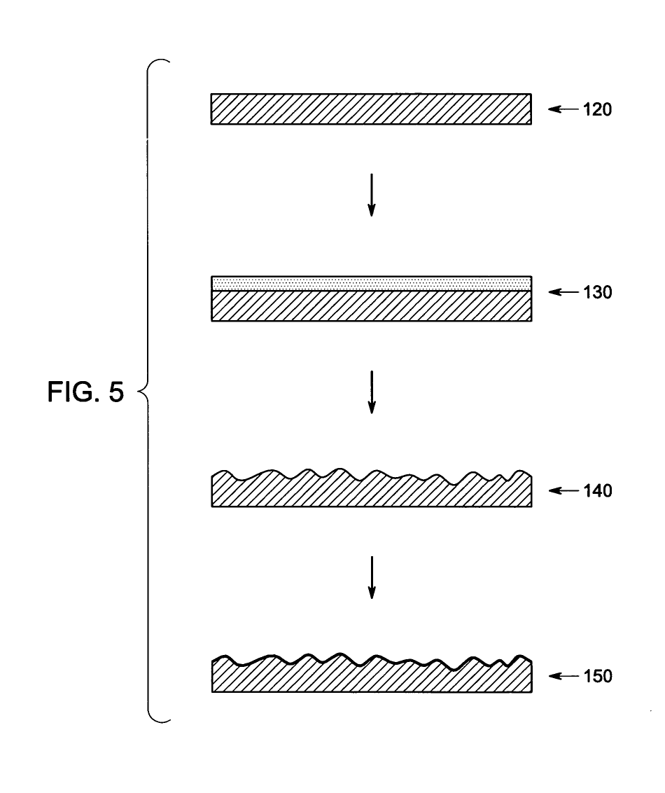

Method 160 shown in FIG. 6 illustrates a flow chart of a method according to another embodiment of the present invention. Referring to FIG. 6, a substrate of a desired size and shape is provided in step 170, a phase transformation is induced at the surface region by contacting the surface with a fluid in step 180, and the phase transformation is arrested by contacting the surface with a quenchant as shown as step 190, wherein the quenchant causes precipitation of the material from the fluid onto the surface. In an exemplary embodiment, a polycarbonate surface is contacted momentarily with tetrahydrofuran wherein there is partial dissolution of the surface. Upon further exposing to a quenchant comprising ethanol, which is a non-solvent in this case, there is precipitation of material with consequent formation of texture on the surface.

Arresting the phase transformation may also include, in some embodiments, inducing a cross linking reaction at the surface region. A cross linking reaction at the surface region may be induced by exposing the surface to a cross linking promoter such as a ultra violet radiation, an electron-beam or other radiation; a chemical cross-linking agent; or heating the surface above the cross linking specific parameters used to achieve the cross linking, will often depend in large part on the materials in use, and are known to those skilled in the art.

In another embodiment, inducing the phase transformation at the surface region includes heating the surface region to above the critical temperature for miscibility or immiscibility of the polymer in a solvent or one polymer in another polymer system (in case of polymer blends), followed by quenching to a temperature below a transition temperature. In one embodiment, the transition temperature is the glass transition temperature. In another embodiment, the transition temperature is a melting temperature. In such embodiments, cooling the substrate below the transition temperature typically arrests the phase transformation.

In one embodiment the polymer-solvent system is heated to a temperature above the temperature at which the material transforms from a two-phase regime into a miscible regime. Upon rapidly cooling this back into the phase-separated region, spinodal decomposition may be encountered, at which point there are wave-like composition fluctuations and growth of interconnected network-like structures. Cooling the material further, below the glass transition temperature, may arrest the formation of these network structures, thereby providing a controlled surface texture. FIG. 7 shows the flow chart of a method 200 involving the steps of providing a substrate comprising a polymer in step 210, exposing to a solvent in step 220 at an elevated temperature, quenching the surface below the transformation temperature of the polymer in step 230, followed by removing the solvent in step 240. In yet another embodiment a surface comprising a polymer-polymer blend is heated above the miscibility temperature for the two polymers, and then cooled rapidly back into the immiscibility region, to below a transformation temperature for one of the polymers, thereby generating a network-like dispersion of one polymer within the other polymer. The dispersed polymer may then be etched out by a selective solvent, retaining the other polymer, and thereby providing texture on the surface. This procedure is not restricted to mixtures that are immiscible at low temperatures and miscible at higher temperatures (Upper Critical Solution Temperature behavior), but can also be applied appropriately to Lower Critical Solution Temperature mixtures (the ones which are miscible at low temperatures and immiscible at high temperatures) as well.

Generally the surface is regenerable, that is, the features are disposed at the surface and in a region extending to a selected depth beneath the surface. The actual depth will vary depending on the intended application, the environment to which the article will be exposed, and the nature of the materials being used. For example, in some embodiments the depth is at least about 5 microns, while in certain embodiments the depth is at least about 50 microns, and in particular embodiments the depth is at least about 200 microns. The depth of texturing may be controlled by the process conditions such as reaction time, temperature and solvent type. In a particular embodiment, the depth of the texture in a polycarbonate substrate is controlled by the time of exposure to acetone. Texturing of the surface of the substrate extending to some depth below the surface provides unique advantages in the durability of the final product. Because the features in these embodiments extend several microns into the surface, the surface is a regenerable surface—that is, removal of features at the surface results merely in the exposure of similar features originally disposed beneath the surface—and so would last outdoors or in a high wear environment for a longer time than an article without features disposed beneath its surface.

The method of the present invention is fundamentally different from those conventionally used in modifying polymer surfaces, such as plasma treatment or texturing observed during film formation in polymer blends or block copolymers. During plasma treatment to modify the surface, the most common phenomenon observed is the cross-linking and/or oxidation of the polymer in plasma, unlike phase transformation that occurs in the above embodiments. The method according to the present invention may be utilized to convert any polymer substrate into a hydrophobic, a hydrophilic, superhydrophilic or a superhydrophobic surface. This method is simple, cost effective, and easy to scale up. Previous attempts in producing superhydrophobic surfaces such as texturing with nanoparticles and sol-gel processing involve elaborate processing steps. The methods based on polymer solution coatings have adhesion-related issues. They also have the problem of short lifetime of coated articles, as the coatings degrade with time. In the present method, since the features extend several microns into the surface, the surface is a regenerable surface and so would last outdoors or in a high wear environment for a substantial time. Methods used for creating multi-level texturing involve tedious lithographic techniques, or micro-casting, or laser-micro processing. In the method of the present invention, the texture is created in situ in the material without an external coating, and the number of processing steps is also significantly less. The method is also generic and can be applied to any kind of polymer.

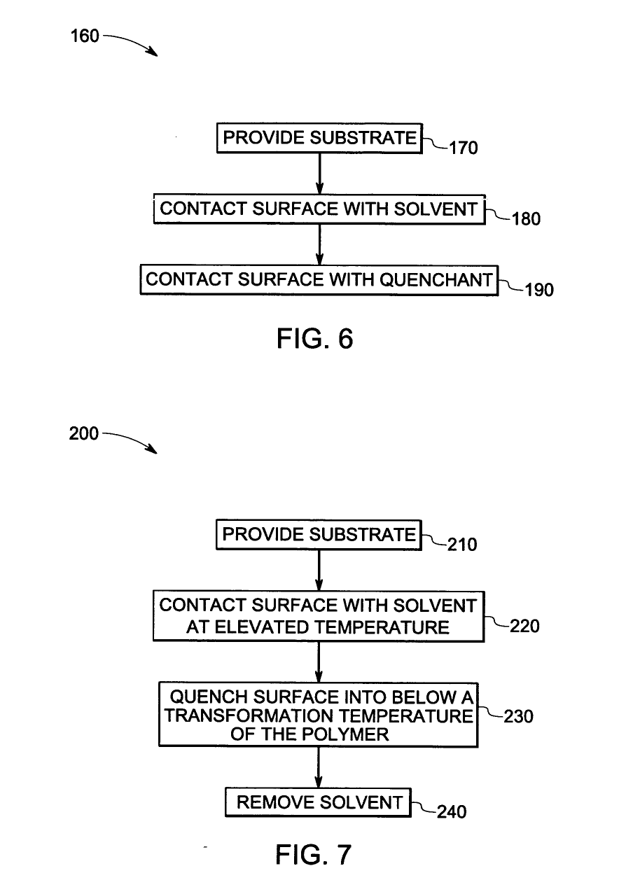

The microstructure and the texture obtained at the selected surface region depend on the substrate material, the solvent chosen, time duration of the reaction, temperature and a number of other parameters. In some embodiments, the average largest characteristic dimension of the plurality of features is about 50 microns. In other embodiments, the average largest characteristic dimension of the plurality of features is about 10 microns. The method according to some embodiments of the present invention advantageously provides a hierarchical structure, that is, the plurality of features comprises features with one characteristic dimension disposed on features with characteristic dimension of another dimension. In an exemplary embodiment the largest characteristic dimension is about 10 microns, and smaller features with a dimension of up to about 100 nm are superimposed on the larger features. In some embodiments, the present invention demonstrates a simple and efficient method to prepare articles with a surface microstructure that mimic the structure of a lotus leaf. In many naturally occurring hydrophobic surfaces such as lotus leaves, many small sized features cover the solid surface, which themselves are covered with smaller sized features so that the contact angle of a liquid drop is high and rolls off the leaf easily. Applicants have found that by the simple method of the present invention, a similar multi-level texturing can be created on a variety of polymer surfaces and they can be made superhydrophobic, or superhydrophilic by optimizing the polymer system and the surface texture. FIG. 8 shows scanning electron micrographs taken on one such surface. Under lower magnification (micrograph 250), the larger length-scale textures are seen. Micrograph 260 shows two-level texturing with a number of nanostructures randomly distributed on micron-sized features.

It is possible to make either hydrophobic or hydrophilic articles by this method. In accordance with some embodiments of the present invention it is possible to achieve superhydrophobicity with static contact angle as high as 170°. In some embodiments, the surface region has a wettability so as to generate a fluid static contact angle of at least about 120 degrees. In one embodiment, the advancing angle formed between a drop of water and a textured substrate was greater than 163° and the receding angle was higher than 150°. In another embodiment, by choosing an appropriate polymer a superhydrophilic surface is obtained. The surface region including the texture has wettability sufficient to generate a fluid contact angle of less than about 60 degrees. Non-limiting examples of polymers that may be made superhydrophilic are poly(ethylene oxide), poly(hydroxy ethyl methacrylate), poly(acrylic acid), poly(acrylamide), poly(styrene sulphonic acid), poly(ethylene imine), poly(vinyl pyrilidone), biopolymers like cellulose acetate etc.

For many applications, apart from desired wettability, optical transparency is also required. Articles may be transparent, translucent, or opaque depending on the length-scale of the morphology. This method provides means of achieving articles with desired wettability retaining optical transparency of polymer substrates. In some embodiments, the article may be advantageously transparent to visible light.

In an exemplary embodiment, the method for making an article includes the steps of: providing a substrate including a polycarbonate material; contacting a selected surface region of the substrate with a fluid including acetone, which induces crystallization, evaporation of fluid from the surface leaves a texture at the surface region. The texture includes a plurality of features having a largest characteristic dimension of up to about 50 microns, wherein the features are disposed on at least about 80% surface area of selected surface region of the substrate. The surface chemistry of the selected surface region is altered, for example, a flurosilane coating is deposited on the selected surface region, to decrease the wettability. Deposition of a flurosilane coating decreases the wettability to generate, with a reference fluid, both advancing and receding angles of atleast about 120 degrees.

In another exemplary embodiment, a method for making an article includes the steps of: providing a substrate with a surface region comprising a copolymer comprising a polycarbonate and a siloxane; contacting the surface with acetone; and evaporating acetone to form a texture at the surface region. The texture comprises a plurality of features having a largest characteristic dimension of up to about 50 microns, and the features are disposed on at least about 80% surface area of selected surface region of the substrate. The surface has wettability sufficient to generate, with a reference fluid, a static contact angle of at least about 120 degrees. The advancing angle was atleast about 120 degrees and the receding angle was atleast about 110 degrees.

The above method could be utilized to make articles with controlled surface wettability for a variety of applications including a laboratory vessel, a wind shield, lenses, vehicular surfaces, out door furniture, household goods, visual signaling devices, video displays green-houses, roofs, marine vessels, for biotechnological applications including membrane separation, anti-bacterial surfaces, micro-fluidic channels, etc. The article may be of any material coated with a polymer. These articles may include any metal, ceramic or composite substrate coated with a plastic film or coating. Exemplary articles include, but are not limited to, airfoils or hydrofoils, pipes and tubing for liquid transport or microfluidic channels or protein separation columns.

The following example serves to illustrate the features and advantages offered by the present invention, and not intended to limit the invention thereto.

### EXAMPLE 1

### Making Lexan polycarbonate superhydrophobic

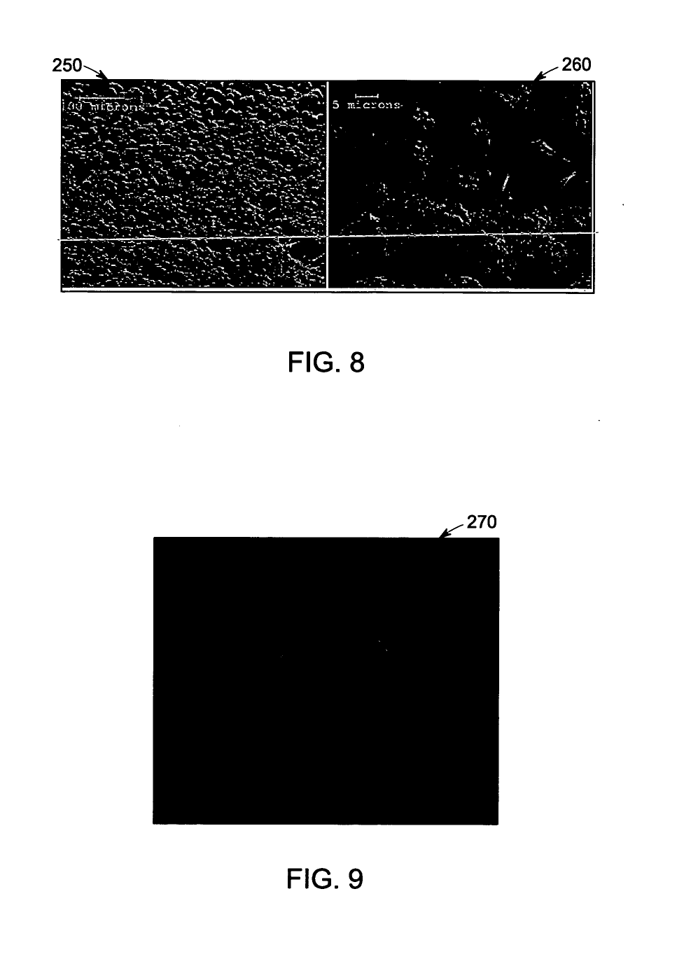

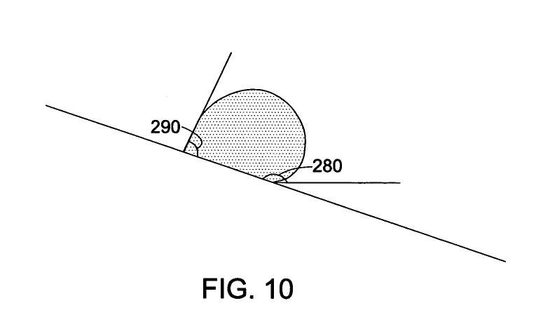

A clean piece of Lexan polycarbonate substrate was provided. A thin layer (˜1-2 mm thick) of acetone was uniformly spread on a piece of polycarbonate and allowed to evaporate in air within a fumehood. Acetone induces crystallization/phase separation on the surface and creates a texture. The water contact angle of Lexan was 93°. After the acetone treatment step the static contact angle increased to 120-140°. This textured polycarbonate coupon was then placed in a dessicator along with a watch glass containing a few drops of 1,1,2,2-tetrahydrofluoro octyl trichlorosilane. Vacuum was pulled for five minutes, then the dessicator was segregated and allowed to equilibrate for 25 minutes, upon which a thin layer of flurosilane was deposited on the Lexan. Contact angle measurements were then conducted on this sample. FIG. 9 shows a photograph 270 of a sessile water droplet on a superhydrophobic surface prepared in accordance with some embodiment of the present invention. The static contact angle is greater than 150 degrees. FIG. 10 shows schematically the advancing angle 280 and receding angle 290 marked for a water droplet on a superhydrophobic surface. The measured advancing angle 280 was greater than 163° and receding angle 290 was higher than 150°.

### EXAMPLE 2

### Making a superhydrophobic copolymer of polycarbonate and siloxane

A clean piece of EXL, a copolymer of polycarbonate and siloxane with 5-6 wt % siloxane functionality was provided. A thin layer (˜1-2 mm thick) of acetone was uniformly spread on this piece and allowed to evaporate in air within a fumehood. Acetone induces crystallization/phase separation on the surface and creates a texture. The water contact angle of EXL was ˜100°. After the acetone treatment step the static contact angle increased to atleast about 125°.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for making an article, the method comprising the steps of:
(a) providing a substrate comprising a polymer; and
(b) inducing a phase transformation at a selected surface region of the substrate, wherein the phase transformation forms a texture at the selected surface region;
wherein the texture comprises a plurality of features having a largest characteristic dimension of up to about 50 microns.

2. The method of claim 1, wherein the substrate comprises a form selected from the group consisting of a sheet, a film, a rod, and a tube.

3. The method of claim 1, wherein the polymer is selected from the group consisting of polycarbonate, polyolefin, polyacrylamide, polystyrene, polyester, polyurethane, acrylic, and blends thereof.

4. The method of claim 1, wherein the substrate comprises a composite.

5. The method of claim 1, wherein the polymer comprises a copolymer comprising a hydrophobic component.

6. The method of claim 5, wherein the copolymer comprises a polycarbonate and a polysiloxane.

7. The method of claim 1, wherein inducing the phase transformation at the surface region comprises contacting the surface region with a fluid.

8. The method of claim 7, wherein the fluid comprises an organic solvent.

9. The method of claim 7, wherein the fluid comprises a mixture of two or more organic solvents.

10. The method of claim 7, wherein the fluid comprises a solvent selected from the group consisting of acetone, butyl acetate, water, ethanol, tetrahydrofuran, and combinations thereof.

11. The method of claim 7, wherein the fluid comprises a supercritical carbon dioxide.

12. The method of claim 1, wherein inducing the phase transformation at the surface region comprises heating the surface region to above a transformation temperature of the polymer.

13. The method of claim 12, wherein the transformation temperature is a glass transition temperature.

14. The method of claim 12, wherein the transformation temperature is a melting temperature.

15. The method of claim 12, wherein inducing phase transformation comprises contacting the surface region with a solvent, and wherein the transformation temperature is that corresponding to a transition between immiscibility and miscibility of the polymer in the solvent.

16. The method of claim 1, wherein the phase transformation comprises one selected from the group consisting of a phase change, and a phase separation.

17. The method of claim 16, wherein the phase change comprises at least one selected from the group consisting of a transition from a crystalline to an amorphous structure, a transition from amorphous to a crystalline phase, a transition from a glassy phase, and a transition to a glassy phase.

18. The method of claim 16, wherein the phase separation comprises at least one selected from the group consisting of separation of a multiphase into constituent phases, dissolution of material from the surface region followed by precipitation back onto the surface.

19. The method of claim 1, further comprising arresting the phase transformation.

20. The method of claim 19, wherein inducing the phase transformation at the surface region comprises contacting the surface with a fluid, and wherein arresting the phase transformation comprises evaporation of fluid from the surface.

21. The method of claim 19, wherein inducing the phase transformation at the surface region comprises contacting the surface with a fluid, and wherein arresting the phase transformation comprises contacting the surface with a quenchant, wherein the quenchant causes precipitation of material from the fluid onto the surface.

22. The method of claim 19, wherein arresting the phase transformation comprises inducing cross-linking reaction at the surface region.

23. The method of claim 22, wherein inducing cross linking reaction at the surface region comprises exposing the surface region to at least one cross linking promoter selected from the group consisting of a ultra violet radiation, an electron-beam radiation, a chemical agent, and a temperature above a cross linking reaction temperature.

24. The method of claim 19, wherein arresting the phase transformation comprises quenching the surface region to a temperature below a transformation temperature of the polymer.

25. The method of claim 1, wherein the plurality of features have a largest characteristic dimension less than about 10 microns.

26. The method of claim 1, wherein the plurality of features form a hierarchical structure.

27. The method of claim 1, wherein the surface region comprising the texture has a wettability of the surface sufficient to generate, with a reference fluid, a static contact angle of at least about 120 degrees.

28. The method of claim 1, wherein the surface region extends below the surface of the substrate to depth at least about 5 microns.

29. The method of claim 28, wherein the method further comprises altering the surface chemistry to achieve a desired wettability.

30. The method of claim 29, wherein altering surface chemistry further comprises at least one process selected from the group consisting of deposition of a coating on the selected surface region, exposing the surface region to a radiation, and exposing the surface to plasma.

31. The method of claim 1, wherein the surface region comprising the texture has a wettability of the surface sufficient to generate, with a reference fluid, a static contact angle of less than about 60 degrees.

32. The method of claim 31, wherein the method further comprises altering surface chemistry to achieve desired wettability of the surface region.

33. The method of claim 32, wherein altering surface chemistry further comprises at least one process selected from the group consisting of deposition of a coating on the selected surface region, exposing the surface region to a radiation, and exposing the surface to plasma.

34. The method of claim 33, wherein the coating on the selected surface region comprises a material selected from the group consisting of flurosilane and diamond like carbon.

35. The method of claim 1, wherein the article is transparent.

36. A method for making an article, the method comprising the steps of:
(a) providing a substrate comprising a polycarbonate material;
(b) contacting a selected surface region of the substrate with a fluid comprising acetone to induce a phase transformation at the selected surface region;
(c) evaporating the fluid from the surface, wherein a texture is formed at the surface region; and
(d) altering surface chemistry of the selected surface region;
wherein the texture comprises a plurality of features having a largest characteristic dimension of up to about 50 microns, wherein the features are disposed on at least about 80% surface area of selected surface region of the substrate and wherein the surface has a wettability sufficient to generate, with a reference fluid, a static contact angle of at least about 120 degrees.

37. A method for making an article, the method comprising the steps of:
providing a substrate with a surface region comprising a copolymer comprising a polycarbonate and a siloxane;
contacting a selected surface region of the substrate with a fluid comprising acetone to induce a phase transformation at the selected surface region; and
evaporating acetone to form a texture at the selected surface region;
wherein the texture comprises a plurality of features having a largest characteristic dimension of up to about 50 microns, and wherein the features are disposed on at least about 80% surface area of selected surface region of the substrate and wherein the surface has a wettability sufficient to generate, with a reference fluid, a static contact angle of at least about 120 degrees.

38. An article comprising a selected surface region comprising a polymer, wherein at least about 80% surface area of selected surface region comprises a plurality of features having a largest characteristic of up to about 50 microns, wherein the plurality of features further comprises a plurality of nanoscale surface features and wherein the selected surface region has the surface wettability sufficient to generate, with a reference fluid, a static contact angle of at least about 120° C.

39. The article of claim 38, wherein the substrate comprises a form selected from the group consisting of a sheet, a film, a rod, and a tube.

40. The article of claim 38, wherein the polymer is selected from the group consisting of a polycarbonate, a polyolefin, a polyacrylamide, a polystyrene, a polyester, a urethane, an acrylic, and a blend thereof.

41. The article of claim 38, wherein the article is a composite.

42. The article of claim 38, wherein the polymer comprises a copolymer comprising a hydrophobic component.

43. The article of claim 42, wherein the copolymer comprises a polycarbonate and a siloxane.

44. The article of claim 38, wherein the plurality of features form a hierarchical structure.

45. An article comprising a selected surface region comprising a polymer, wherein at least about 80% surface area of selected surface region comprises a plurality of features having a largest characteristic dimension of up to about 50 microns, wherein the plurality of features further comprises a plurality of nanoscale surface features and wherein the selected surface region has the surface wettability sufficient to generate, with a reference fluid, a static contact angle of at less than about 45° C.
